(19) United States
(12) Patent Application Publication
(10) Pub. No.: US 2023/0264451 A1
(43) Pub. Date: Aug. 24, 2023

(54) COMPOSITE SANDWICH STRUCTURE

(71) Applicant: Shkamb Koshi, llandriano (IT)

(72) Inventor: Shkamb Koshi, llandriano (IT)

(21) Appl. No.: 18/086,578

(22) Filed: Dec. 21, 2022

Related U.S. Application Data
(60) Provisional application No. 63/402,956, filed on Sep. 1, 2022.

(51) Int. Cl. B32B 3/18; B32B 7/14; B32B 5/18; B32B 37/22

(52) U.S. Cl. CPC B32B 3/18; B32B 7/14; B32B 5/18; B32B 37/22; B32B 2250/40; B32B 2262/106; B32B 2262/101; B32B 2262/0269; B32B 2266/0235; B32B 2266/0264; B32B 2266/0228; B32B 2305/022; B32B 2327/06; B32B 2367/00; B32B 2325/00; B32B 2250/03; B32B 2260/02; B32B 2260/046; B32B 2305/10

(57) ABSTRACT

A composite sandwich structure that includes a top layer; a bottom layer; and a plurality of units sandwiched between the top layer and the bottom layer. Each of the plurality of units has a core made of hard foam and a reinforcement fiber wrap wrapped around the core and secured to the core using a double adhesive tape. The top layer, the bottom layer, and the plurality of units are laminated together using resin.

### CROSS-REFERENCE TO RELATED APPLICATIONS

This application claims priority from a U.S. Provisional Patent Appl. No. 63/402,956 filed on Sep. 1, 2022, which is incorporated herein by reference in its entirety.

### FIELD OF INVENTION

The present invention relates to a composite sandwich panel, and more particularly, the present invention relates to a panel with a core layer in which the core layer is laminated with reinforcement fibers.

### BACKGROUND

Composite sandwich structures are a special type of composite structure in which a lightweight core is sandwiched between two skins of laminate. The composite sandwich structures have high bending stiffness with overall low density because of the thick and low-density core. Composite sandwich structures find use in many applications, such as wings of airplanes, hulls of boats, and many others. Besides being widely used, the known composite sandwich structures suffer from one major limitation i.e., delamination when the composite sandwich structure is put under excessive effort/force/stress. Under these conditions, the material inside the composite sandwich structure can separate/detach/break/cut (delamination). The division/break usually happens in the most stressed point of the structure, the middle. The stress is caused by two opposite forces: flexion and compression.

The delamination negatively affects the compactness of all materials in the structure, and therefore the performance of the structure (its materials no longer work in the same way). The core foam is the soul of the sandwich, it keeps the outer and inner layers of fibers compact and makes them mechanically work together. The core foam allows it to reach very high thicknesses and therefore rigid final product characteristics, without increasing the weight of the structure.

All the core foams on the market suffer from cuts/delamination when the final product is subjected to continuous stress. This is due to their poor mechanical characteristics.

A need is therefore appreciated for improved composite sandwich structures that are devoid of the aforesaid drawbacks with conventional composite sandwich structures.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a novel composite sandwich structure in which the risk of delamination is significantly reduced.

It is another object of the present invention that the weight of the composite structure can be further reduced.

It is still another object of the present invention that the method allows manual placement of composite.

In one aspect, disclosed is a composite sandwich structure comprising a top layer; a bottom layer; and a plurality of units sandwiched between the top layer and the bottom layer. Each unit of the plurality of units comprises a core, reinforcement fiber wrap wrapped around the core, and a double adhesive tape disposed on an inner surface of the reinforcement fiber wrap, the double adhesive tape configured to secure the reinforcement fiber wrap to the core. The plurality of units are arranged side-by-side, and the top layer, the bottom layer, and the plurality of units are secured by a resin. The reinforcement fiber wrap is made from carbon fiber, glass fiber, or Kevlar fiber. The core is composed of hard foam. The hard foam is selected from a group consisting of PVC, PET, Balsa, and XPS. The core is of a triangular shape or a trapezoid shape.

In one aspect, disclosed is a unit of a composite sandwich structure comprising a core; a reinforcement fiber wrap wrapped around the core, and a double adhesive tape disposed on an inner surface of the reinforcement fiber wrap, the double adhesive tape configured to secure the reinforcement fiber wrap to the core. The reinforcement fiber wrap is made from carbon fiber, glass fiber, or Kevlar fiber. The core is composed of hard foam. The hard foam is selected from a group consisting of PVC, PET, Balsa, and XPS. The core is of a triangular shape or a trapezoid shape.

In one aspect, disclosed is a method for manufacturing a structure, the method comprising the steps of providing a composite sandwich structure comprising a top layer, a bottom layer, and a plurality of units sandwiched between the top layer and the bottom layer. Each unit of the plurality of units comprises a core, reinforcement fiber wrap wrapped around the core, and a double adhesive tape disposed on an inner surface of the reinforcement fiber wrap, the double adhesive tape configured to secure the reinforcement fiber wrap to the core. The plurality of units are arranged side-by-side, and the top layer, the bottom layer, and the plurality of units are secured by a resin. The reinforcement fiber wrap is made from carbon fiber, glass fiber, or Kevlar fiber. The core is composed of hard foam. The hard foam is selected from a group consisting of PVC, PET, Balsa, and XPS. The core is of a triangular shape or a trapezoid shape.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 illustrates the making of a unit of the composite sandwich structure, according to an exemplary embodiment of the present invention.

FIG. 2 shows the unit of the composite sandwich structure, according to an exemplary embodiment of the present invention.

FIG. 3 shows an arrangement of units in the composite sandwich structure, according to an exemplary embodiment of the present invention.

FIG. 4 shows the composite sandwich structure, according to an exemplary embodiment of the present invention.

FIGS. 5a-5d show different profiles of the units of the composite sandwich structure, according to an exemplary embodiment of the present invention.

FIGS. 6a-6d show the different composite structure panels made from the units shown in FIGS. 5a-5d respectively, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation.

Disclosed is a novel composite sandwich structure or panel, and a method for manufacturing thereof that by having a novel orientation of the reinforcement fibers significantly reduces the risks of breakage or delamination. The disclosed method is also advantageous by allowing for manual labor and unlimited shapes of the final product.

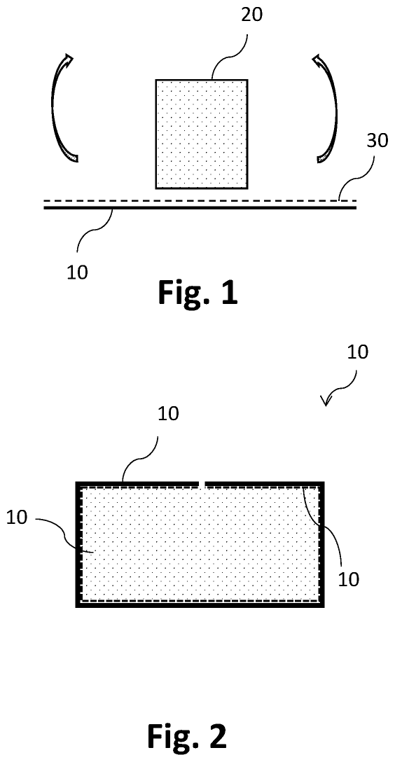

FIG. 1 illustrates an exemplary embodiment of manufacturing a unit of the disclosed composite sandwich panel. The disclosed composite sandwich structure includes a top layer, a bottom layer, and a middle-sandwiched core layer. The core layer includes laminated reinforcement fibers that provide enhanced strength without increasing the overall weight of the composite.

The reinforcement fibers used in the disclosed composite sandwich structure can be carbon fibers, glass fibers, Kevlar fibers, and the like fibers known to a skilled person for use in composite sandwich structures. The core foam can be hard such as, but not limited to, PVC, PET, Balsa, and XPS.

FIG. 1 illustrates the making of a unit of the disclosed composite sandwich structures. The unit includes a reinforcement fiber wrap 10, a core 20, and a double tape adhesive 30. The reinforcement fiber wrap 10 can be wrapped around the core 20 in a specific orientation as shown in FIGS. 1 and 2 using a double adhesive tape 30. Instead of double adhesive tape, spray glue adhesive can also be used. The reinforcement fiber wrap 10 can completely wrap the core foam. These reinforcements distribute the stress away from the core foam, improving the strength. The reinforcement fiber wrap has a proximal edge and a distal edge, the proximal edge and the distal edge are on opposite sides of the reinforcement fiber wrap, when wrapped, the proximal edge contacts the distal edge but does not overlap.

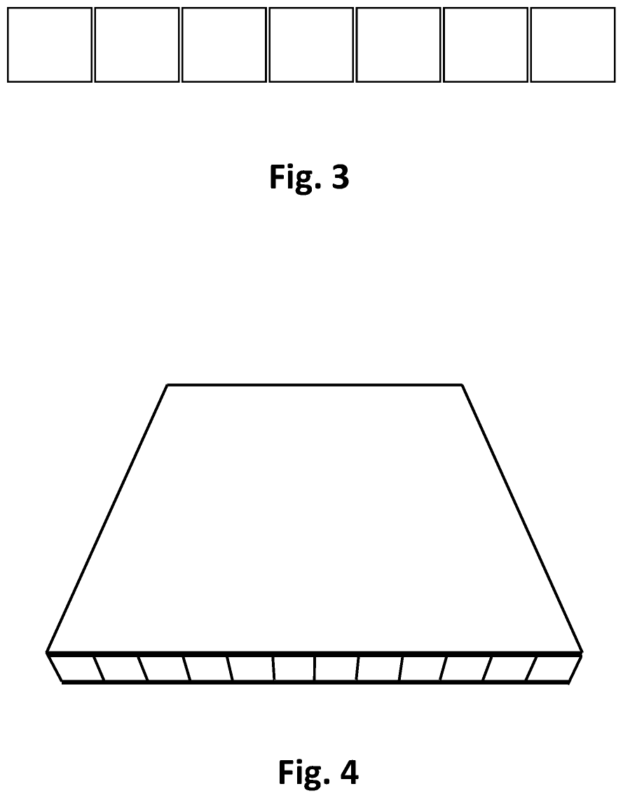

The units as shown in FIG. 2 can be arranged side-by-side in the disclosed composite sandwich structure. FIG. 3 shows such an arrangement of the units that are arranged side-by-side to form the core layer of the composite sandwich structure. The core layer can be sandwiched between the reinforcing top layer and the bottom layer to form the disclosed composite sandwich structure. For sandwiching the core layer between the top layer and the bottom layer, suitable resins can be used. The use of such resins is known to a skilled person for making composite laminates. An exemplary embodiment of the composite sandwich structure is shown in FIG. 4 which has a top layer, a core layer, and a bottom layer.

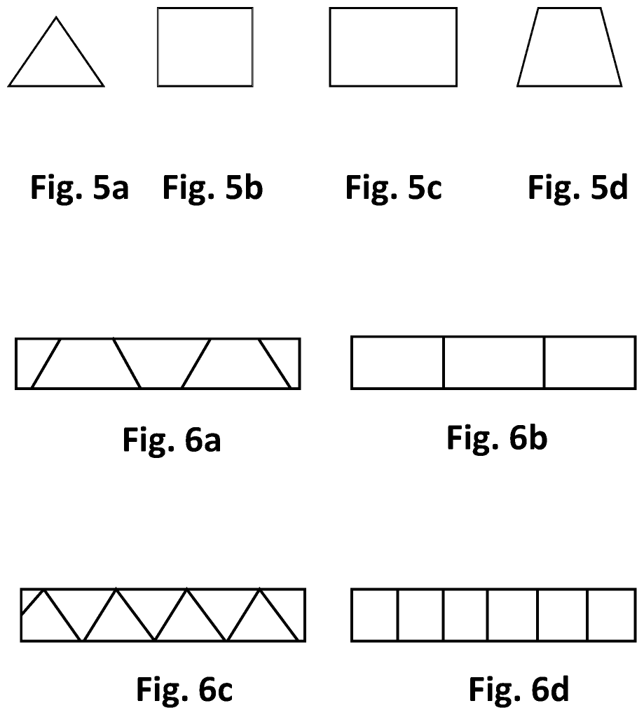

The units can be provided in different profiles and sizes by having core foams of different shapes. FIG. 5a shows the unit with a triangular profile, FIG. 5b shows the unit with a square profile, FIG. 5c shows the unit with a rectangular profile, and FIG. 5d shows the unit with a trapezoid profile. FIGS. 6a-6d show the respective composite sandwich structures made from the units shown in FIGS. 5a-5d.

The use of a dual adhesive layer in the disclosed units achieves the best weight fiber/resin ratio because it minimizes the excess resin that can enter the opened cells of the foam. The top and bottom layers can be laminated by any standard process known to a skilled person for manufacturing laminates and any such process is within the scope of the present invention. The structure can be completed in one or two infusions. The two-infusion process reduces the surface distortions on the structure and is advised to avoid potential aesthetic anomalies. The two-infusion process consists of infusing the top layer (the externally visible one) on its own, and post-cure it to stabilize it against thermal anomalies. Then the second infusion can be done to complete the structure.

The disclosed composite sandwich structure offers many advantages over conventional composite structures including reduced weight (4x lighter than current technology), increased robustness/stiffness, and increased structural durability. When used in boat construction, the disclosed composite sandwich structures offer additional advantages: lower horsepower required/higher speed with the same horsepower; fuel efficiency; less maintenance required; increased comfort during the ride because of the stiffness of the structure. The disclosed composite sandwich structure can be used in wind blades, bridges, infrastructure tooling and machinery, mega-constructions, aviation, and the like industries.

The disclosed composite sandwich structure was compared with a standard composite sandwich structure by using the same in a 31 feet center console boat. It was found that the boat using the disclosed composite weighs 1.5 tons compared to the 4-5 tons boat made with a conventional composite structure. Both the top speed and the fuel efficiency were also significantly improved.

In one implementation, the core foam in the units can be wrapped from many weights and seams of fiber reinforcement. Preferably, a biaxial +45/−45 fiber reinforcement can be used.

In one implementation, the disclosed method allows the use of more flexible and less dense core materials, such as XPS that allow the units to be positioned by hand on the mold, making it very easy to shape the final product on complex and irregular surfaces.

The disclosed composite sandwich panels were evaluated for breaking point using a standard procedure and the results were compared with a conventional composite sandwich structure. It was found that the standard panel delaminated to a press force of 341 kN while the disclosed composite sandwich structure didn't laminate by breaking at a force press of 1299 kN. When the disclosed composite sandwich structure is made from a soft foam core material, such as XPS, it can be deformed by hand without breaking shape.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A composite sandwich structure comprising:
a top layer;
a bottom layer; and
a plurality of units sandwiched between the top layer and the bottom layer, wherein each unit of the plurality of units comprises:
a core,
reinforcement fiber wrap wrapped around the core, and
a double adhesive tape disposed on an inner surface of the reinforcement fiber wrap, the double adhesive tape configured to secure the reinforcement fiber wrap to the core.

2. The composite sandwich structure according to claim 1, wherein the plurality of units are arranged side-by-side, and the top layer, the bottom layer, and the plurality of units are secured by a resin.

3. The composite sandwich structure according to claim 1, wherein the reinforcement fiber wrap is made from carbon fiber, glass fiber, or Kevlar fiber.

4. The composite sandwich structure according to claim 1, wherein the core is composed of hard foam.

5. The composite sandwich structure according to claim 3, wherein the hard foam is selected from a group consisting of PVC, PET, Balsa, and XPS.

6. The composite sandwich structure according to claim 1, wherein the core is of a triangular shape or a trapezoid shape.

7. A unit of a composite sandwich structure comprising:
a core;
reinforcement fiber wrap wrapped around the core, and
a double adhesive tape disposed on an inner surface of the reinforcement fiber wrap, the double adhesive tape configured to secure the reinforcement fiber wrap to the core.

8. The unit according to claim 7, wherein the reinforcement fiber wrap is made from carbon fiber, glass fiber, or Kevlar fiber.

9. The unit according to claim 7, wherein the core is composed of hard foam.

10. The unit according to claim 9, wherein the hard foam is selected from a group consisting of PVC, PET, Balsa, and XPS.

11. The unit according to claim 7, wherein the core is of a triangular shape or a trapezoid shape.

12. A method for manufacturing a structure, the method comprising the steps of:
providing a composite sandwich structure comprising:
a top layer,
a bottom layer, and
a plurality of units sandwiched between the top layer and the bottom layer, wherein each unit of the plurality of units comprises:
a core,
reinforcement fiber wrap wrapped around the core, and
a double adhesive tape disposed on an inner surface of the reinforcement fiber wrap, the double adhesive tape configured to secure the reinforcement fiber wrap to the core.

13. The method according to claim 12, wherein the plurality of units are arranged side-by-side, and the top layer, the bottom layer, and the plurality of units are secured by a resin.

14. The method according to claim 12, wherein the reinforcement fiber wrap is made from carbon fiber, glass fiber, or Kevlar fiber.

15. The method according to claim 12, wherein the core is composed of hard foam.

16. The method according to claim 15, wherein the hard foam is selected from a group consisting of PVC, PET, Balsa, and XPS.

17. The method according to claim 12, wherein the core is of a triangular shape or a trapezoid shape.
